(19) United States
(12) Patent Application Publication
(10) Pub. No.: US 2003/0080202 A1
(43) Pub. Date: May 1, 2003

(54) Fuel-injection system

(76) Inventors: Franz Rieger, Aalen (DE); Thomas Ludwig, Huenxe (DE); Hans Schlembach, Muehlacker (DE); Gottlob Haag, Markgroeningen (DE); Ulrich Brenner, Moeglingen (DE); Michael Huebel, Gerlingen (DE); Juergen Stein, Illingen (DE); Udo Sieber, Bietigheim (DE)

Correspondence Address: KENYON & KENYON, ONE BROADWAY, NEW YORK, NY, 10004, US

(21) Appl. No.: 10/182,219

(22) PCT Filed: Nov. 26, 2001
(86) PCT No.: PCT/DE01/04402

(30) Foreign Application Priority Data
Nov. 28, 2000 (DE) 100590098

(51) Int. Cl. F02M 45/10

(52) U.S. Cl. 239/95

(57) ABSTRACT

In a fuel-injection system, a fuel injector (1) has a valve-closure member (4), which cooperates with a valve seat surface (6) on a valve seat element (5) to form a sealing seat. At least one spray-discharge opening (7. 49) is situated downstream of the sealing seat and it is sealed from a fuel inlet (16) by the sealing seat. The spray-discharge opening (7, 49) has a spray-shaping section (34) which is made of a thin-walled wall section of the spray-discharge opening (7, 49) lying opposite to a pressure chamber (44), and the pressure chamber (44) may have pressure applied to it by a pressure fluid.

### BACKGROUND INFORMATION

The present invention is based on a fuel injection system of the type set forth in the main claim.

A fuel injector is known from DE 44 34 892, which has a first pressure spring and a second pressure spring, which are positioned one behind the other. A valve needle having a valve-closure member is prestressed against a sealing seat by the first pressure spring via a driving pin device. When the valve needle is lifted off from the sealing seat by an electromagnetic actuator, at first only the spring force of the first pressure spring counters this motion. After a certain partial lift, the driving pin device strikes a spring system disk of the second pressure spring. If the valve needle having the valve-closure member is further lifted from the sealing seat, then the first and second pressure springs counter this lift. The opening cross section in the sealing seat may be controlled by the size of the lift. Depending upon the current flowing in the magnetic actuator, therefore, the flow rate of the fuel injector may be controlled, since the spring constant rises sharply as soon as the second pressure spring additionally applies a counterforce to the valve needle.

However, the disadvantage of this known fuel injector is that the regulation of the flow rate takes place in two stages. A selective influencing of the spray pattern is achieved only with difficulty.

A fuel injector is known from DE 27 11 391 A1 which has a hydraulically controllable operating piston. This operating piston as a stop limits the possible lift of a valve needle. In this context, the operating piston is shifted from an output position in the closing direction of the valve needle at increasing pressure of the hydraulic fluid that controls it.

What is disadvantageous in this related art is that only one regulation of the flow rate of the fuel is possible. In particular, the shape of the spray-discharge jet cannot be controlled. Above all, in the case of very low flow rates, this may lead to problems when a spray-discharge opening has too large a cross section compared to the flow rate, and adequate distribution of the fuel in the jet pattern of the fuel injector does not take place.

### SUMMARY OF THE INVENTION

By contrast, the fuel injection system according to the present invention, having the characterizing features of the main claim, has the advantage that it makes possible a stepless regulation of the flow rate. At the same time, by the formation of a rounded narrowing portion of the spray-discharge opening of the fuel injector, the fuel flow is made to lie adjacent to one wall of the spray-discharge opening when hydraulic fluid is applied to the pressure chamber. This causes the fuel to undergo acceleration directed towards the wall of the spray-discharge opening in the region where the narrowing widens again, and the forming of a jet pattern becomes possible even at low flow rates. In particular, the jet pattern in relation to the flow rate may be set by the position and the length of the spray-shaping section in the spray-discharge opening, since the forming of the jet pattern is effected by the throttling of the flow rate at the same time.

The measures specified in the subclaims permit advantageous further developments and improvements of the compensating element indicated in the main claim.

The spray-discharge opening of the fuel injector may advantageously penetrate the pressure chamber, and thus the spray-shaping section may be designed as a sleeve-shaped wall section of the spray-discharge opening.

The spray-shaping section may favorably be made of a thin walled sleeve, set into the spray-discharge opening, which may extend to where the spray-discharge opening opens out, and may lie adjacent thereto with its integrally formed flange.

In this design the spray-shaping section is cost-effectively made with low production variance. Also, the choice of a suitable material for the sleeve makes it easy to set the elastic properties by which the measure of the bulging of the sleeve under pressure is determined.

Advantageously, a pressure fluid inlet may be connected to the pressure chamber via a 3/2-directional control valve and the pressure chamber may be connected to a pressure fluid outlet via a 3/2-directional control valve.

A pressure fluid inlet may be connected to the pressure chamber via a throttle and the pressure chamber may be connected to a pressure fluid outlet via a 2/2-directional control valve.

Conveniently, another swirl disk may be positioned upstream of the sealing seat.

This generates a rotation of the flowing fuel, and, due to the centrifugal force, an effective acceleration in the direction of the wall of the spray-discharge opening, and reinforces the spray-shaping effect of the spray-shaping section.

### BRIEF DESCRIPTION OF THE DRAWINGS

Exemplary embodiments of the present invention of a fuel injection system are shown simplified in the drawings, and are explained more precisely in the description below. The figures show:

FIG. 1 a schematic section through an exemplary embodiment of a fuel injector of a fuel injection system according to the present invention.

FIG. 2 a schematic partial section through an exemplary embodiment of a fuel injection system according to the present invention in region II in FIG. 1.

FIG. 3 a schematic partial section through a further exemplary embodiment of a fuel injection system according to the present invention in region II in FIG. 1.

FIG. 4 a schematic top view of a swirl element of the exemplary embodiment in FIG. 1.

### DESCRIPTION OF THE EXEMPLARY EMBODIMENTS

Fuel injector 1 of a fuel injection system is designed in the form of a fuel injector 1 for fuel-injection systems of mixture-compressing internal combustion engines with externally supplied ignition. Fuel injector 1 is particularly suitable for directly injecting fuel into a combustion chamber (not shown) of an internal combustion engine.

Fuel injector 1 includes a nozzle body 2, in which a valve needle 3 is positioned. Valve needle 3 is connected in operative connection to a valve-closure member 4 that cooperates with a valve-seat surface 6, arranged on a valve-seat member 5, to form a sealing seat. Fuel injector 1 in the exemplary embodiment is an inwardly opening fuel injector 1 which has a spray-discharge opening 7. Nozzle body 2 is sealed from external pole 9 of a magnetic coil 10 by a seal 8. Magnetic coil 10 is encapsulated in a coil housing 11 and wound on a bobbin 12, which lies adjacent to an internal pole 13 of magnetic coil 10. Internal pole 13 and external pole 9 are separated from each other by a gap 26 and are supported on a connecting component 29. Magnetic coil 10 is energized via an electric line 19 by an electric current, which can be supplied via an electrical plug-in contact 17. A plastic jacket 18, which may be sprayed onto internal pole 13, encloses plug-in contact 17.

Valve needle 3 is guided in a valve needle guide 14, which is designed as a disk. A paired adjustment disk 15 is used to adjust the (valve) lift. An armature 20 is on the other side of adjustment disk 15. It is connected by force-locking to valve needle 3 via a first flange 21, and valve needle 3 is connected to first flange 21 by a welded seam 22. Supported on first flange 21 is a restoring spring 23 which, in the present design of fuel injector 1, is prestressed by a sleeve 24.

A second flange 31, which is connected to valve needle 3 via a welded seam 33, is used as lower armature stop. An elastic intermediate ring 32 resting on second flange 31 prevents rebounding when fuel injector 1 is closed.

Fuel channels 30a and 30b run in valve-needle guide 14 and in armature 20. The fuel is supplied through a central fuel feed 16 and filtered by a filter element 25. Fuel injector 1 is sealed by seal 28 from a fuel line (not shown).

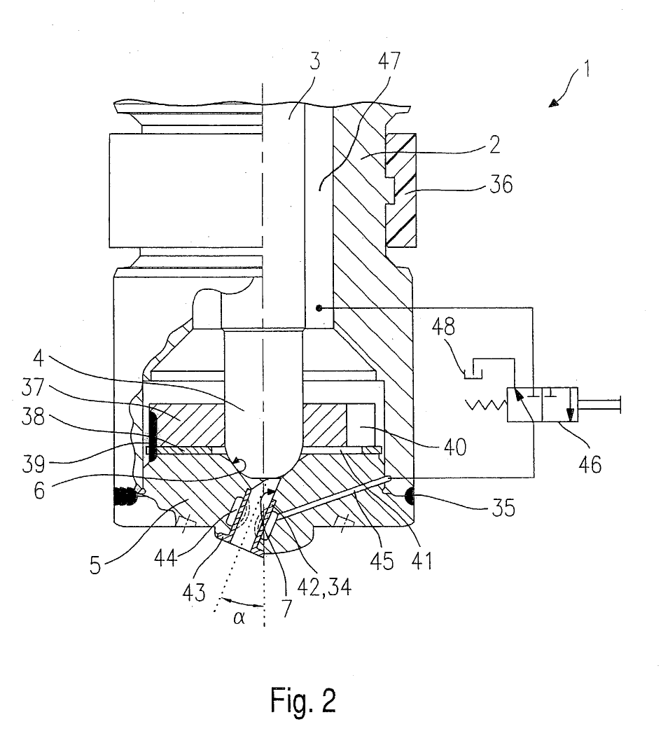

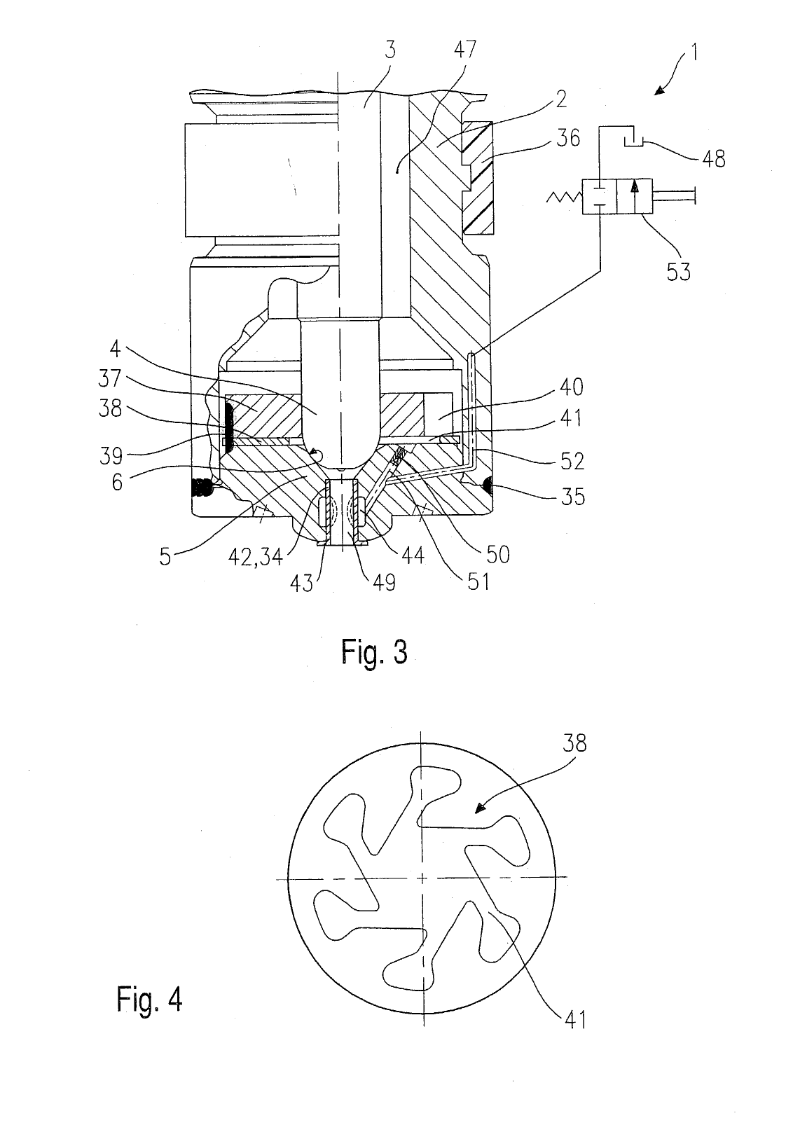

At spray-discharge opening 7 a spray-shaping section 34 is formed, which, in the present exemplary embodiment, is designed as a sleeve inserted into the spray-discharge opening. A detailed illustration of spray-shaping section 34 may be seen in FIGS. 2 and 3.

In the neutral position of fuel injector 1, return spring 23 acts upon armature 20 counter to its lift direction in such a way that valve-closure member 4 is retained in sealing contact against valve seat surface 6. Upon excitation of magnetic coil 10, the latter generates a magnetic field which moves armature 20 in the lift direction, counter to the spring force of return spring 23, the lift being predefined by a working gap 27 existing in the neutral position between internal pole 12 and armature 20. Armature 20 also carries along in the lift direction flange 21, which is welded to valve needle 3. Valve-closure member 4, being in operative connection with valve needle, lifts off from valve seat surface 6 and fuel is supplied to spray-discharge opening 7.

When the coil current is switched off, after sufficient decay of the magnetic field, armature 20 falls away from internal pole 13 because of the pressure of return spring 23, whereupon flange 21, being operatively connected to valve needle 3, moves in a direction counter to the lift direction. Thereby valve needle 3 is moved in the same direction in which valve-closing member 4 sets down upon valve seat surface 6 and fuel injector 1 is closed.

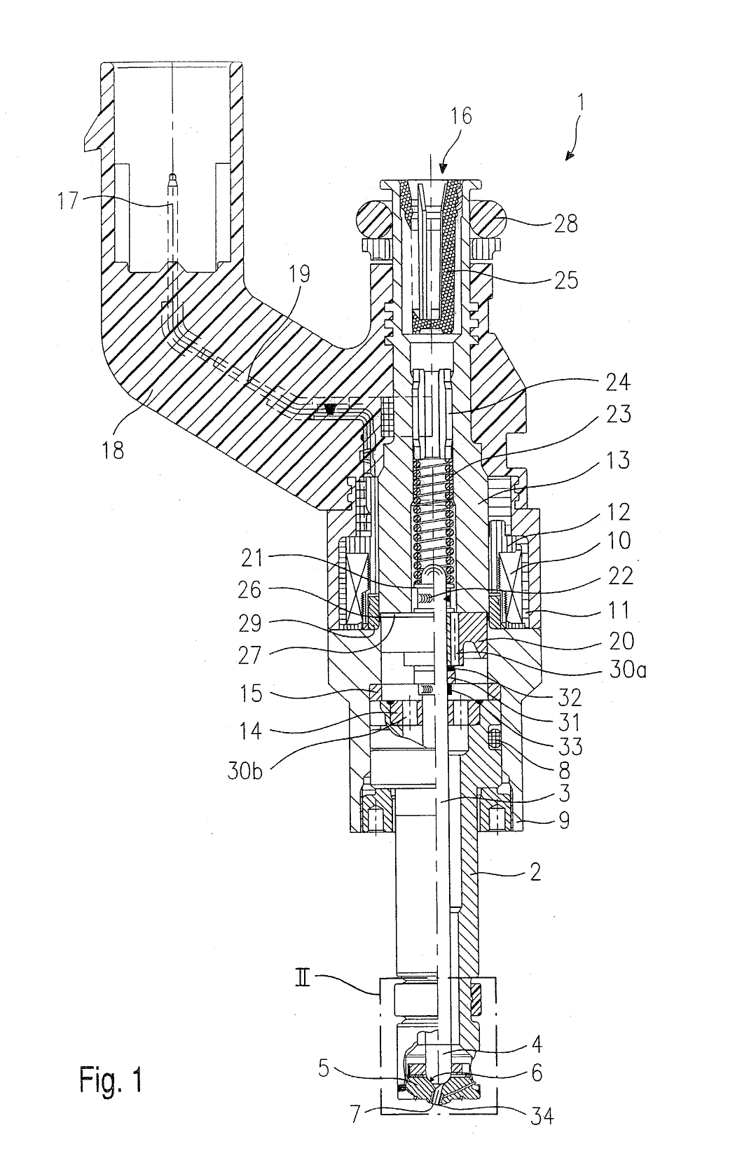

FIG. 2 shows in an excerpted sectional illustration a magnified view of the part on the spray-discharge side of the first exemplary embodiment of a fuel injector 1 of a fuel injection system according to the present invention. The section shown is denoted as II in FIG. 1. Here, components identical to those in FIG. 1 are marked with the same reference numerals.

Valve seat element 5 is connected to nozzle body 2 via a welded seam 35. The valve-closure member 4 cooperates with valve-seat surface 6 to form a sealing seat. A sealing ring 36 is used to seal fuel injector 1 from the bore hole of a cylinder head (not shown). Valve needle 3 is formed as one piece with valve-closure member 4 and is in operative connection with it. In this context, valve needle 3 reaches through a guide element 37 as well as a swirl element 38. Swirl element 38 is positioned between guide element 37 and valve seat element 5. Guide element 37, swirl element 38 and valve seat element 5 are connected to one another via a welded seam 39. The fuel reaches the sealing seat at valve seat surface 6 via supply regions 40, of which only one is shown in section in the drawing, and swirl channels 41.

A sleeve 42 is inserted into spray-discharge opening 7 as spray-shaping section 34, which extends to the opening out of spray-discharge opening 7 on the combustion chamber side and lies adjacent to the opening out of spray-discharge opening 7 with its flange 43. Spray-discharge opening 7 is positioned at an angle a to the center axis of fuel injector 1. Spray-shaping section 34 is surrounded by a pressure chamber 44, spray-discharge opening 7 in the exemplary embodiment described penetrating pressure chamber 44, and consequently, pressure chamber 44 encloses spray-discharge opening 7 radially on the outside over its entire circumference. The length of sleeve 42 that forms spray-shaping section 34 is greater than the length of pressure chamber 44 in the direction of extension of spray-discharge opening 7. Pressure chamber 44 is connected to a 3/2-directional control valve 46 via a control bore 45. This 3/2-directional control valve 46 is only represented by its hydraulic switching symbol and may be designed to be outside fuel injector 1 as well as to be integrated into it. Pressure chamber 44 may be connected, via 3/2-directional control valve 46, to a fuel chamber 47, which is connected to central fuel supply 16 and receives fuel under pressure of central fuel supply 16. This connecting possibility is shown schematically in the drawing by a connecting line. In the other switching position of 3/2-directional control valve 46, shown here, pressure chamber 44 may be connected to fuel discharge 48. In the selected exemplary embodiment, the fuel itself is used as the pressure fluid applied to pressure chamber 44.

While fuel injector 1 is closed and valve-closure body 4 lies against valve seat surface 6, if fuel under pressure is applied to pressure chamber 44 via 3/2-directional control valve 46, sleeve 42 is deformed elastically in the region of its longitudinal extension where it is surrounded by pressure chamber 44. The deformation is indicated by hatched lines, Since sleeve 42 forming jet shaping section 34 is formed longer in the direction of extension of spray-discharge opening 7 than is pressure chamber 44, a constricting deformation of spray-discharge opening 7 takes place only in the region of pressure chamber 44, and, in particular, no gradation is formed in spray-discharge opening 7. Now, when fuel injector 1 is opened and valve-closure member 4 is lifted off valve seat surface 6, the flow of fuel in spray-discharge opening 7 is throttled by the constriction in spray-shaping section 34 and the injected quantity is decreased. At the same time, a radially outward acceleration of the fuel in the region of the opening out of spray-discharge opening 7 takes place. This effect comes about due to the flow of the fuel taking place against the wall of the spray-shaping section 34 and because of a radially outward-directed force component of the flowing fuel reinforced by its rotation. The rotation results from its flowing through swirl element 38 and swirl channels 41. Since the length and the elasticity of sleeve 42 are optional, the throttling and widening of the fuel jet can hereby be set independently of one another.

FIG. 3 shows in an excerpted sectional illustration an enlarged view of the part of a fuel injector 1 on the spray-discharge side of a further fuel injection system according to the present invention. The excerpt corresponds to section II in FIG. 1, and parts of fuel injector 1 which are the same or equivalent to those in FIG. 1 are provided with the same reference numerals.

Nozzle body 2 is connected to valve seat element 5 by welded seam 35. Valve-closure member 4, which is formed as one part with valve needle 3, cooperates with valve seat surface 6 to form a sealing seat. Sealing ring 36 is used to seal fuel injector 1 from the bore hole of a cylinder head (not shown). Valve needle 3 is guided by guiding element 37, which fixes swirl element 38 to valve seat element 5 at the same time. Guide element 37, swirl element 38 and valve seat element 5 are connected to one another via welded seam 39. The fuel reaches the sealing seat at valve seat surface 6 via inlet regions 40 and swirl channels 41.

A spray-discharge opening 49 is here situated centrally along a center axis of fuel injector 1. Sleeve 42 is inserted as spray-shaping section 34, which extends to the opening out of spray-discharge opening 49 on the combustion chamber side and lies adjacent to the opening out of spray-discharge opening 49 with its flange 43. Spray-shaping section 34 is surrounded by pressure chamber 44. Pressure chamber 44 is connected to a fuel chamber 47, via a throttle 50 and a supply bore 51, which is connected to central fuel supply 16 and receives fuel under pressure of central fuel supply 16. Pressure chamber 44 may be connected to a fuel discharge 48 via a control channel 52 and a 2/2-directional control valve 53. The 2/2-directional control valve 53 is only represented by its hydraulic switching symbol and may be designed to be outside fuel injector 1 as well as to be integrated into it. Fuel discharge 48, too, is only shown as a symbol in the drawings. In the selected exemplary embodiment, the fuel itself is used as the pressure fluid applied to pressure chamber 44.

Fuel constantly under pressure flows into pressure chamber 44 via throttle 50. For that reason, sleeve 42 is deformed inwards in the region of pressure chamber 44. The degree of deformation may be regulated by the pressure in pressure chamber 44. This is done by opening or closing 2/2-directional control valve 53. If more fuel is discharged than continues flowing into pressure chamber 44 via throttle 50, the pressure decreases. This specific embodiment of the present invention makes possible a more exact regulation of pressure in pressure chamber 44, as a function of the response and the switching speed of 2/2-directional control valve 53.

FIG. 4 shows a top view of an exemplary design of swirl element 38 having swirl channels 41 that are directed radially inwards and running tangentially. When the fuel flows through the swirl channels 41, it is set into rotational motion which reinforces the effect of the spray-shaping, in particular at low flow rate and great bulging of spray-shaping section 34.

What is claimed is:

1. A fuel-injection system having a fuel injector (1), especially for internal combustion engines, which has a valve-closure member (4) that cooperates with a valve seat surface (6) on a valve seat element (5) to form a sealing seat, at least one spray-discharge opening (7, 49) being situated downstream of the sealing seat, which is sealed by the sealing seat,
wherein the spray-discharge opening (7, 49) has a spray-shaping section (34) which is made of a thin-walled wall section of the spray-discharge opening (7, 49) lying opposite to a pressure chamber (44), and the pressure chamber (44) may have pressure applied to it by a pressure fluid.

2. The fuel-injection system as recited in claim 1,
wherein fuel is used as the pressure fluid.

3. The fuel-injection system as recited in claim 1 or 2,
wherein the spray-discharge opening (7, 49) runs through the pressure chamber (44).

4. The fuel-injection system as recited in one of claims 1 through 3,
wherein the spray-shaping section (34) is made of a thin-walled sleeve (42) set into the spray-discharge opening (7, 49).

5. The fuel-injection system as recited in claim 4,
wherein the sleeve (42) extends to the opening out of the spray-discharge opening (7, 49) and lies adjacent to the opening out with its integrally formed flange (43).

6. The fuel-injection system as recited in claim 4 or 5,
wherein the pressure chamber (44) does not extend over the entire length of the sleeve (42).

7. The fuel-injection system as recited in one of claims 1 through 6,
wherein a pressure fluid inlet (16) is connected to the pressure chamber (44) via a 3/2-directional control valve (46) and the pressure chamber (44) is connected to a pressure fluid outlet (48) via the 3/2-directional control valve.

8. The fuel-injection system as recited in claim 7,
wherein the 3/2-directional control valve (46) is integrated into the fuel injector (1).

9. The fuel-injection system as recited in one of claims 1 through 6,
wherein a pressure fluid inlet (16) is connected to the pressure chamber (44) via a throttle (50), and the pressure chamber (44) is connected to a pressure fluid outlet (48) via the 2/2-directional control valve (53).

10. The fuel injector as recited in claim 9,
wherein the 2/2-directional control valve (53) is integrated into the fuel injector (1).

11. The fuel injector as recited in one of claims 1 through 10,
wherein a swirl element (38) is situated in the fuel inlet, upstream of the sealing seat, on valve seat element (5).

12. The fuel injector as recited in one of claims 1 through 11,
wherein the axis of the spray-discharge opening (7) is tilted with respect to the center axis of the fuel injector (1).
